(19) United States
(12) Patent Application Publication
(10) Pub. No.: US 2026/0316261 A1
(43) Pub. Date: Oct. 15, 2026

(54) CONVEYANCE DEVICE AND CONTROLLING METHOD THEREFOR

(71) Applicant: DAIFUKU CO., LTD., Osaka (JP)

(72) Inventors: Takahiro YOSHIDA, Tokyo (JP); Tsutomu ISHIHARA, Tokyo (JP); Hiroyuki EBINA, Tokyo (JP); Kozo HASEGAWA, Tokyo (JP)

(73) Assignee: DAIFUKU CO., LTD., Osaka (JP)

(21) Appl. No.: 19/638,689

(22) Filed: Apr. 3, 2026

(30) Foreign Application Priority Data
Apr. 9, 2025 (JP) 2025-064498

(51) Int. Cl. B25J 9/00; B25J 5/02; B25J 9/16

(52) U.S. Cl. CPC B25J 9/0093; B25J 5/02; B25J 9/1651

(57) ABSTRACT

In order to achieve an assembly line unlikely to be damaged, a conveyance device, which conveys an operation robot configured to carry out an operation on a target article being conveyed, includes a placement section on which the operation robot is placed, a conveyance section configured to move in a direction identical to a conveyance direction of the target article at a conveyance speed identical to that of the target article, and a coupling section coupling the placement section and the conveyance section, the coupling section including a floating mechanism configured to permit movement in a direction parallel to the conveyance direction between the placement section and the conveyance section.

This Nonprovisional application claims priority under 35 U.S.C. § 119 on Patent Application No. 2025-064498 filed in Japan on Apr. 9, 2025, the entire contents of which are hereby incorporated by reference.

### TECHNICAL FIELD

The present disclosure relates to, for example, a conveyance device and the like for conveying an operation robot configured to carry out an operation in an assembly line or the like.

### BACKGROUND ART

In, for example, assembly lines for automobiles, a vehicle body under assembly is assembled by an assembly robot while being conveyed by a conveyor machine. At this time, the assembly robot carries out assembly with a part thereof docked with a part of the vehicle body while moving at the same speed as the conveyance speed of the vehicle body.

For example, Patent Literature 1 discloses a device used in a bolt/nut supply device for an automobile assembly line or the like, a device including a floating section that permits movement of a supply shaft section in horizontal and vertical directions.

### CITATION LIST

### Patent Literature

Patent Literature 1

Japanese Patent Application Publication Tokukai No. 2002-254258

### SUMMARY OF INVENTION

### Technical Problem

As described above, during assembly, part of a vehicle body and part of an assembly robot are docked. In a case where conveyance of the vehicle body and movement of the assembly robot stop for any reason during the docking, a shift occurs in a relative position between the vehicle body and the assembly robot since the vehicle body and the assembly robot are different in the braking distance. This may lead to damage to the vehicle body or the assembly robot.

Patent Literature 1 is silent about damage caused by the positional shift of a vehicle body with an assembly robot.

The present invention has been made in light of the foregoing problem, and it is an object thereof to achieve, for example, a conveyance device for an assembly robot which makes it unlikely for a vehicle body or the assembly robot to be damaged even when a positional shift occurs between the vehicle body and the assembly robot.

### Solution to Problem

In order to attain the object, a conveyance device in accordance with an aspect of the present disclosure is a conveyance device for an operation robot configured to carry out an operation on a target article being conveyed, the conveyance device including: a placement section on which the operation robot is placed; a conveyance section configured to move in a direction identical to a conveyance direction of the target article at a conveyance speed identical to that of the target article; and a coupling section coupling the placement section and the conveyance section, the coupling section including a floating mechanism configured to permit movement in a direction parallel to the conveyance direction between the placement section and the conveyance section.

A conveyance device controlling method in accordance with an aspect of the present disclosure is a controlling method for a conveyance device for an operation robot configured to carry out an operation on a target article being conveyed, the conveyance device including a placement section on which the operation robot is placed, a conveyance section configured to move in a direction identical to a conveyance direction of the target article at a conveyance speed identical to that of the target article, and a coupling section coupling the placement section and the conveyance section, the coupling section including a floating mechanism configured to permit movement in the conveyance direction between the placement section and the conveyance section, the conveyance device further including a regulation mechanism control section configured to control regulation of a floating function of the floating mechanism by a regulation mechanism, the method including: a detection step of using the regulation mechanism control section to detect an abnormality in the operation; and a release step of using the regulation mechanism control section to release regulation by the regulation mechanism when the abnormality is detected.

### Advantageous Effects of Invention

According to an aspect of the present disclosure, it is possible to prevent damage to a target article or an operation robot.

### BRIEF DESCRIPTION OF DRAWINGS

FIG. 1 is a view illustrating a conveyance device and a controller in accordance with an embodiment of the present disclosure.

FIG. 2 is a view illustrating another example of the controller.

FIG. 3 is a view simply illustrating an example of a regulation mechanism.

FIG. 4 is a view simply illustrating another example of the regulation mechanism.

FIG. 5 is a view simply illustrating still another example of the regulation mechanism.

FIG. 6 is a flowchart illustrating a flow of a regulation process by a regulation mechanism control section.

### DESCRIPTION OF EMBODIMENTS

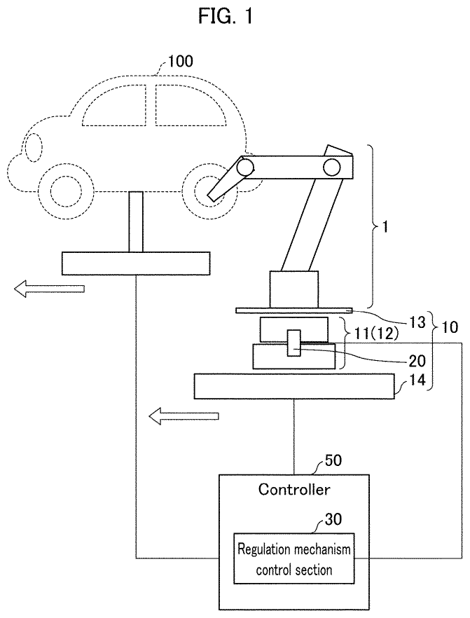

The following description will discuss an embodiment of the present disclosure in detail. FIG. 1 is a view illustrating one example of a manufacture line including a conveyance device 10 in accordance with the present embodiment. Here, as one example of the manufacture line, an assembly line for automobiles is illustrated.

In the assembly line, the conveyance device 10 conveys an operation robot 1 configured to carry out an operation on a target article 100 in an assembly line. The operation robot 1 is conveyed by the conveyance device 10 in a direction identical to and at a speed identical to those of the target article 100, and carries out an operation on the target article 100. The movement of the target article 100 and the operation robot 1 in the same direction at the same speed enables an appropriate operation on the target article 100 by the operation robot 1.

As illustrated in FIG. 1, the conveyance device 10 includes a placement section 13, a coupling section 11, and a conveyance section 14.

The placement section 13 is a section on which the operation robot 1 is placed. The conveyance section 14 is configured to move in a direction identical to the conveyance direction of the target article 100 at a conveyance speed identical to that of the target article 100. The coupling section 11 couples the placement section 13 and the conveyance section 14 and includes a floating mechanism 12 and a regulation mechanism 20.

The floating mechanism 12 permits, between the placement section 13 and the conveyance section 14, movement in a direction parallel to the conveyance direction.

The regulation mechanism 20 is configured to regulate the floating function of the floating mechanism 12. In a case where the floating function of the floating mechanism 12 is regulated by the regulation mechanism 20, the placement section 13 and the conveyance section 14 are connected without play. In contrast, in a case where the floating function of the floating mechanism 12 is not regulated by the regulation mechanism 20, the placement section 13 and the conveyance section 14 are connected with play in the conveyance direction. That is, a positional shift between the placement section 13 and the conveyance section 14 is permitted by a length permitted by the floating mechanism 12. Hereinafter, regulating the floating function of the floating mechanism 12 is also referred to simply as regulating the floating mechanism 12. Further, releasing the regulation of the floating function of the floating mechanism 12 is also referred to simply as releasing the regulation of the floating mechanism 12.

A separate controller 50 configured to control the entire assembly line is provided. The controller 50 includes a regulation mechanism control section 30. The regulation mechanism control section 30 is configured to control whether or not the regulation of the floating mechanism 12 by the regulation mechanism 20 is carried out.

For example, in a case where the following conditions (1) to (3) are satisfied, the regulation mechanism control section 30 may release the regulation of the floating mechanism 12 by the regulation mechanism 20.
(1) A case where a difference between the conveyance speed of the target article 100 and the conveyance speed of the conveyance section 14 exceeds a first threshold or a case where a difference between the current position of the target article 100 and the current position of the operation robot 1 exceeds a second threshold.
(2) A case where an abnormality is detected in the operation robot 1.
(3) A case where a signal regarding an abnormality is received from equipment for conveying the target article 100.

Regarding the above condition (1), the conveyance speed of the target article 100 and the conveyance speed of the operation robot 1 can be measured through a known technique. The regulation mechanism control section 30 determines whether or not a difference between the conveyance speed of the target article 100 and the conveyance speed of the operation robot 1, which is measured through a known technique, exceeds the first threshold, and releases the regulation by the regulation mechanism 20 in a case where the difference exceeds the first threshold. Examples of the first threshold include a speed difference that causes detection of a stress corresponding to 80% of an allowable stress of a specific component, or a speed difference that causes an error in a relative position between the target article 100 and the conveyance section 14 to be ±2 mm or more.

Further, the current position of the target article 100 and the current position of the operation robot 1 can be grasped, for example, by the following methods.
(i) The current positions are grasped by attaching position information stickers to the target article 100 and the operation robot 1 and capturing images of the position information stickers with use of, for example, a camera. The position information sticker may be, for example, a QR code (registered trademark).
(ii) The current positions are grasped by capturing images of the target article 100 and the operation robot 1 with use of, for example, a camera.
(iii) The current positions of the target article 100 and the operation robot 1 are grasped from information obtained by an encoder (not illustrated).

The second threshold may be, for example, X±2 mm. Here, X refers to the difference between the position of the target article 100 and the position of the operation robot 1 when the operation is normally carried out.

Regarding the above condition (2), for example, an abnormality may be detected in the operation robot 1 in a case where a force sensor included in a connection part (not illustrated) of the operation robot 1 that is connected to the target article 100 detects an abnormal value. Alternatively, an abnormality may be detected in a case where a current value resulting from an action of the operation robot 1 in operation becomes an abnormal value. Further, an abnormality may be detected in a case where various values (e.g., a current value and a torque value) measured in the operation of the operation robot 1 become abnormal. Alternatively, an abnormality may be detected in a case where a torque value of a motor (not illustrated) included in the operation robot 1 becomes abnormal.

Regarding the above condition (3), the content of the abnormality and the signal regarding the abnormality are not particularly limited. For example, an event regarded as abnormal may be set in advance, and a signal regarding the abnormality may be received when the event occurs.

For example, in a case where the regulation mechanism 20 is configured to carry out control by a biasing force described later, the regulation mechanism control section 30 controls the regulation by the regulation mechanism 20 by controlling the biasing force. Further, in a case where the regulation mechanism 20 is achieved with use of an electromagnet, the regulation by the regulation mechanism 20 is controlled by controlling a current provided to the electromagnet.

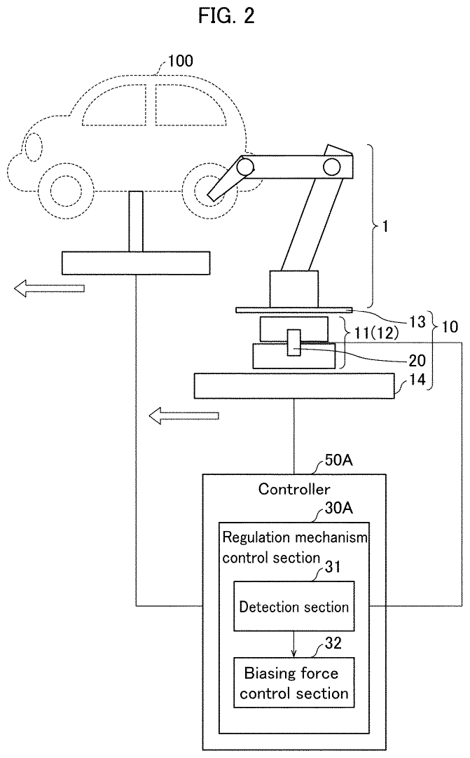

FIG. 2 illustrates a controller 50A, which is another example of the controller 50. The controller 50A in FIG. 2 is illustrated as an example including, in a regulation mechanism control section 30A, a detection section 31 and a biasing force control section 32.

The detection section 31 is configured to detect an abnormality in the assembly line in operation. The abnormality in the assembly line may be a condition (release condition) for the regulation mechanism control section 30 described above to release the regulation. That is, the regulation mechanism control section 30 may detect that the release condition is satisfied with use of the detection section 31 and then release the regulation by the regulation mechanism 20.

The biasing force control section 32 controls a biasing force of a biasing section 212 (described later) in the regulation mechanism 20. Specifically, when the detection section 31 detects an abnormality, the biasing force control section 32 controls the biasing force of the biasing section 212 to release the regulation by the regulation mechanism 20. As described later, in a case where the regulation mechanism 20 is configured to regulate the floating mechanism 12 by the biasing force of the biasing section 212, the regulation by the regulation mechanism 20 can be controlled by controlling the biasing force of the biasing section 212. For example, the regulation can be carried out with the biasing force set to be equal to or greater than a preset value (predetermined value), and the regulation can be released by making the biasing force smaller than the predetermined value.

In other words, in the regulation mechanism 20 described later, with a protrusion 21 thereof fitted into a receiving hole 221, when the biasing force is equal to or greater than a predetermined value, the regulation mechanism control section 30 does not permit movement in the conveyance direction between the placement section 13 and the conveyance section 14. In contrast, when the biasing force is smaller than the predetermined value, the regulation mechanism control section 30 permits the movement in the conveyance direction between the placement section 13 and the conveyance section 14.

As such, the conveyance device 10 in accordance with the present disclosure is a conveyance device for the operation robot 1 configured to carry out an operation on the target article 100 being conveyed. The conveyance device 10 includes the placement section 13 on which the operation robot 1 is placed, the conveyance section 14 configured to move in a direction identical to the conveyance direction of the target article 100 at a conveyance speed identical to that of the target article 100, and the coupling section 11 coupling the placement section 13 and the conveyance section 14. The coupling section 11 includes the floating mechanism 12 configured to permit movement in a direction parallel to the conveyance direction between the placement section 13 and the conveyance section 14.

In the conventional assembly line, a configuration has not been employed in which a floating mechanism is provided in a conveyance device configured to convey an operation robot. In the conveyance device 10 in accordance with the present disclosure, the floating mechanism 12 is disposed between the placement section 13 and the conveyance section 14. The floating mechanism 12 permits a positional shift between the placement section 13 and the conveyance section 14. Therefore, even if conveyance of the target article 100 stops during an operation, and a positional shift is about to occur between the target article 100 and the operation robot 1, the positional shift is permitted by the floating mechanism 12 between the placement section 13 on which the operation robot 1 is placed and the conveyance section 14 conveying the operation robot 1. Therefore, the positional shift between the target article 100 and the operation robot 1 is absorbed. This makes it possible to prevent damage to the target article 100 or the operation robot 1.

Further, by disposing the floating mechanism 12 disposed between the placement section 13 and the conveyance section 14, it becomes sufficient to configure the floating mechanism 12 to permit a positional shift between the placement section 13 and the conveyance section 14 merely in the direction parallel to the conveyance direction, thereby enabling simplification of the structure of the floating mechanism 12.

### Structure Example of Regulation Mechanism 20

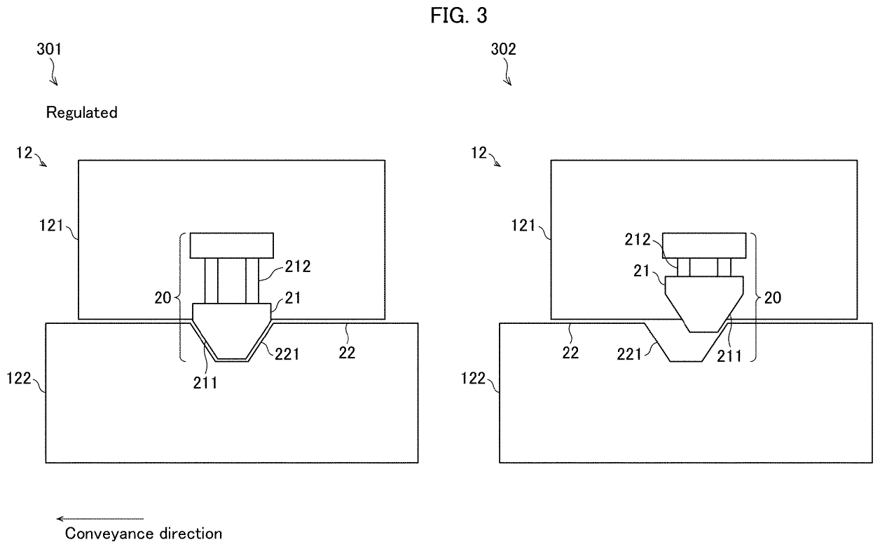

Next, with reference to FIGS. 3 to 5, the following will describe examples of the regulation mechanism 20. FIGS. 3 to 5 are cross-sectional views illustrating structural examples of the regulation mechanism 20. FIGS. 3 to 5 illustrate cross-sections of the regulation mechanisms 20 (20A and 20B) taken along the conveyance direction.

### Structural Example 1

FIG. 3 illustrates one example of the structure of the regulation mechanism 20. Reference numeral 301 of FIG. 3 indicates a state in which the floating mechanism 12 is regulated by the regulation mechanism 20, and reference numeral 302 of FIG. 3 indicates a state in which the regulation by the regulation mechanism 20 is released.

In the floating mechanism 12, the regulation mechanism 20 includes a first part 121 connected to the placement section 13 and a second part 122 connected to the conveyance section 14. The first part 121 is provided with the protrusion 21. The protrusion 21 is biased toward the second part 122 by the biasing section 212, and is fitted into the receiving hole 221 provided in the second part 122. The biasing section 212 may bias the protrusion 21, for example, by a force of gas (such as air) supplied. Alternatively, the biasing section 212 may be made of an elastic body, such as a spring, and may bias the protrusion 21 by a restoring force of the elastic body.

The protrusion 21 is provided with a tapered portion 211 on a side surface thereof located on a tip side and facing in a conveyance direction. The receiving hole 221 is formed so that the surface thereof facing in the conveyance direction is shaped so as to be complementary to the tapered portion 211 of the protrusion 21.

The protrusion 21 that is biased by the biasing section 212 is fitted into the receiving hole 221, thereby fixing the first part 121 and the second part 122, so that the floating mechanism 12 is regulated. This state refers to the state in which the floating mechanism 12 is regulated.

In contrast, the state in which the regulation of the floating mechanism 12 is released refers to a state in which the protrusion 21 can come off from the receiving hole 221. In a case where the biasing section 212 carries out the biasing by a force of gas, the state in which the protrusion 21 can come off from the receiving hole 221 can be created by weakening or eliminating the force of gas. In a case where the biasing section 212 is made of an elastic body, the state can be created by applying a force in a direction opposite to a direction in which the biasing is carried out by the restoring force.

In the example illustrated in FIG. 3, a side surface of the protrusion 21 facing in the conveyance direction is the tapered portion 211, and a surface of the receiving hole 221 is also shaped so as to be complementary to the tapered portion 211 of the protrusion 21, so that the regulation by the regulation mechanism 20 can be released by weakening the biasing force of the biasing section 212. Further, by controlling the biasing force, it is possible to control a degree of regulation by the regulation mechanism 20, in other words, a distance by which a shift is permitted.

As such, the floating mechanism 12 includes the first part 121 connected to the placement section 13 and the second part 122 connected to the conveyance section 14. The first part 121 has the protrusion 21 that has a tapered shape and that is biased toward the conveyance section 14 by a variable biasing force of the biasing section 212. The second part 122 includes a plate part 22 provided with the receiving hole 221 having a side surface facing in a direction parallel to the conveyance direction and having a tapered shape into which the protrusion 21 is fitted. The regulation mechanism 20 is formed by the protrusion 21 and the plate part 22, and carries out the regulation through the fitting of the protrusion 21 into the receiving hole 221 by the biasing force of the biasing section 212.

As described above, the regulation mechanism 20 achieves the regulation through fitting of the protrusion 21 and the receiving hole 221 by a biasing force. Therefore, when a force is applied in a direction that weakens the biasing force of the regulation mechanism 20 for any reason such as occurrence of an abnormality, the regulation is released. For example, when a force that causes a shift in the relative position between the target article 100 and the operation robot 1 is applied due to, for example, an abnormality, the regulation of the floating mechanism 12 is released. As described above, according to the regulation mechanism 20 in accordance with the present disclosure, it is possible to release the regulation of the floating mechanism 12 without requiring any special process, for example, in a case where an abnormality occurs.

### Structural Example 2

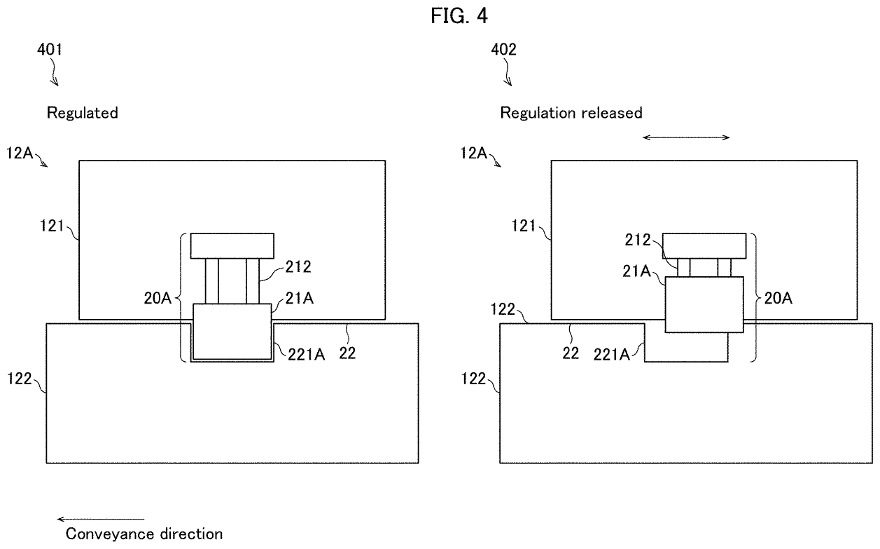

FIG. 4 illustrates a regulation mechanism 20A, which is another structural example of the regulation mechanism 20. Reference numeral 401 of FIG. 4 indicates a state in which the floating mechanism 12 is regulated by the regulation mechanism 20A, and reference numeral 402 of FIG. 4 indicates a state in which the regulation by the regulation mechanism 20A is released.

The regulation mechanism 20A illustrated in FIG. 4 differs from the regulation mechanism 20 illustrated in FIG. 3 in that no tapered portion is provided at the end of a protrusion 21A, and the protrusion 21A having a rectangular cross-section has a shape to be fitted into a receiving hole 221A provided in the second part 122.

The regulation mechanism 20A illustrated in FIG. 4 can also carry out the regulation by the regulation mechanism 20 through fitting of the protrusion 21A into the receiving hole 221. Further, the regulation by the regulation mechanism 20 can be released by complete disengagement of the protrusion 21A from the receiving hole 221. In this case, for example, the biasing section 212 may be provided with a pulling section (not illustrated), and the pulling section may pull the protrusion 21A toward the first part 121 to completely disengage the protrusion 21A from the receiving hole 221.

In other words, the floating mechanism 12 includes the first part 121 connected to the placement section 13 and the second part 122 connected to the conveyance section 14. The first part 121 has the protrusion 21A, and the second part 122 includes the plate part 22 provided with the receiving hole 221A into which the protrusion 21A is fitted. The regulation mechanism 20A is formed by the protrusion 21A and the plate part 22, and carries out the regulation through fitting of the protrusion 21A into the receiving hole 221A.

### structural Example 3

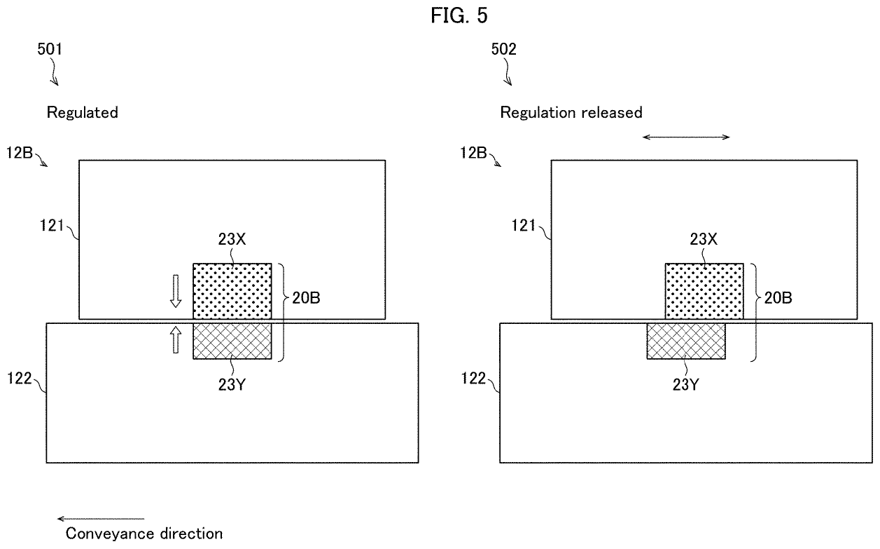

FIG. 5 illustrates a regulation mechanism 20B, which is still another structural example of the regulation mechanism 20. Reference numeral 501 of FIG. 5 indicates a state in which the floating mechanism 12 is regulated by the regulation mechanism 20B, and reference numeral 502 of FIG. 5 indicates a state in which the regulation by the regulation mechanism 20B is released.

In the example illustrated in FIG. 5, the first part 121 is provided with an electromagnet 23X, and the second part 122 is provided with a magnet 23Y. The regulation mechanism 20B regulates the floating mechanism 12 through coupling of the electromagnet 23X and the magnet 23Y by a magnetic force. That is, for carrying out the regulation by the regulation mechanism 20B, a current is caused to pass through the electromagnet 23X, thereby causing the electromagnet 23X to act as a magnet and to be coupled with the magnet 23Y. In contrast, for releasing the regulation by the regulation mechanism 20B, no current is caused to pass through the electromagnet 23X, thereby bringing the electromagnet 23X and the magnet 23Y into a state of not being coupled. This makes it possible to control the regulation by the regulation mechanism 20B.

Note that both the electromagnet 23X and the magnet 23Y may be electromagnets. The magnet 23Y may be an electromagnet.

According to the above configuration, the coupling section 11 can carry out coupling by a magnetic force. Further, it can be said that the regulation of the function of the floating mechanism 12 is released when generation of the magnetic force is stopped or when a force exceeding the coupling by the magnetic force is applied.

### Flow of Process

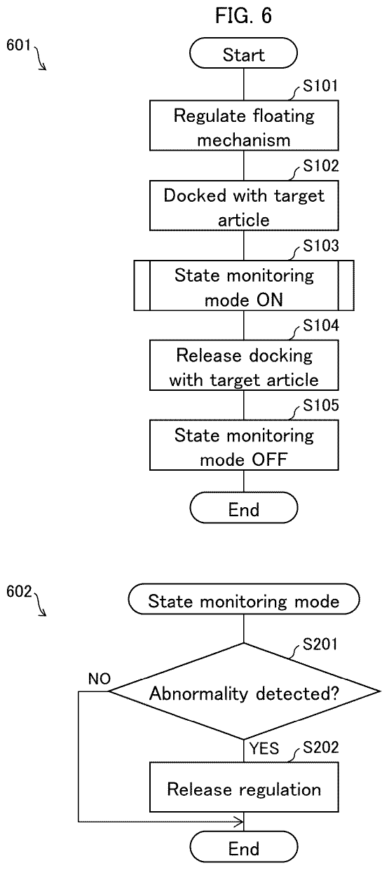

With reference to FIG. 6, the following will describe an example of a case where regulation by the regulation mechanism control section 30 is carried out in the present embodiment. FIG. 6 is a flowchart illustrating a flow of a regulation process by the regulation mechanism control section 30. Here, the following will describe a flow of a process carried out when an abnormality has occurred in an assembly line.

As indicated by reference numeral 601 of FIG. 6, in an assembly line, regulation by the regulation mechanism 20 is being carried out (S101). When the operation robot 1 is then connected (docked) to the target article 100 (S102), a state monitoring mode is turned on (S103). Thereafter, operation by the operation robot 1 proceeds, and when the operation is completed, the docking between the operation robot 1 and the target article 100 is released (S104). The state monitoring mode is then turned off (S105). The state monitoring mode refers to a mode in which the controller 50 monitors the state of the assembly line.

Reference numeral 602 of FIG. 6 indicates a flow of a process carried out when the state monitoring mode is turned on. With the state monitoring mode in an on state, when an abnormality is detected in the assembly line (YES in S201, detection step), the regulation mechanism control section 30 releases the regulation by the regulation mechanism 20 (S202, release step). This releases the regulation of the floating function by the floating mechanism 12. This causes the operation robot 1 to move together with the target article 100 even if a positional shift is about to occur between the target article 100 and the operation robot 1. A shift in a relative position between the conveyance device 10 conveying the operation robot 1 and the target article 100 is thus permitted. Therefore, it is possible to reduce a risk of occurrence of troubles, damage, and the like even if a positional shift is about to occur between the target article 100 and the operation robot 1 while they are connected.

The foregoing has been a description of a flow of the process carried out when an abnormality has occurred in an assembly line.

The above description has been provided on the assumption that the target article 100 is to be conveyed, but the invention in accordance with the present disclosure is not limited to this. Even in a case where the target article 100 is not conveyed, for example, a configuration may be employed in which at the time point when the operation robot 1 grips an assembly component and the like to be assembled to the target article 100, the state monitoring mode is turned on to carry out the state monitoring.

Further, although the foregoing has described a configuration in which the regulation is released when an abnormality is detected, timing for releasing the regulation is not limited to the case where an abnormality is detected. For example, a configuration may be employed in which in a case where a regulation release flag, which is a command to release the regulation mechanism, is detected, the regulation mechanism control section releases the regulation by the regulation mechanism.

### Software Implementation Example

The functions of the regulation mechanism control section 30 can be realized by a program for causing a computer to function as the regulation mechanism control section 30, the program causing the computer to function as the regulation mechanism control section 30.

In this case, the regulation mechanism control section 30 includes, as hardware for executing the program, a computer that includes at least one control device (e.g., a processor) and at least one storage device (e.g., a memory). The control device and the storage device execute the program, so that the functions described in the above embodiments are realized.

The program may be recorded in one or more non-transitory computer-readable recording media. The one or more recording media may or may not be included in the control device. In the latter case, the program can be supplied to the device via any wired or wireless transmission medium.

Alternatively, some or all of the functions of the regulation mechanism control section 30 can be realized by a logic circuit. For example, the present disclosure encompasses, in its scope, an integrated circuit in which a logic circuit that functions as each of the control blocks is formed. In addition, the function of each of the control blocks can be realized by, for example, a quantum computer.

Further, each of the processes described in the above embodiments can be executed by artificial intelligence (AI). In this case, the AI may be operated by the control device or may be operated by another device (for example, an edge computer and a cloud server).

Aspects of the present invention can also be ex-pressed as follows:

A conveyance device in accordance with Aspect 1 of the present disclosure is a conveyance device for an operation robot configured to carry out an operation on a target article being conveyed, the conveyance device including: a placement section on which the operation robot is placed; a conveyance section configured to move in a direction identical to a conveyance direction of the target article at a conveyance speed identical to that of the target article; and a coupling section coupling the placement section and the conveyance section, the coupling section including a floating mechanism configured to permit movement in a direction parallel to the conveyance direction between the placement section and the conveyance section.

Conventionally, a configuration in which a floating mechanism is disposed between a placement section and a conveyance section has not existed. According to the above configuration, the floating mechanism is disposed between the placement section and the conveyance section, and the floating mechanism permits a positional shift between the placement section and the conveyance section. Therefore, even if conveyance of the target article stops during an operation, and a positional shift is about to occur between the target article and the operation robot, a positional shift is permitted by the floating mechanism between the placement section on which the operation robot is placed and the conveyance section conveying the operation robot, so that a positional shift between the target article and the operation robot is absorbed. This makes it possible to prevent damage to the target article or the operation robot.

Further, by disposing the floating mechanism between the placement section and the conveyance section, it becomes sufficient to configure the floating mechanism to permit a positional shift between the placement section and the conveyance section merely in the direction parallel to the conveyance direction, thereby enabling simplification of the structure of the floating mechanism.

A conveyance device in accordance with Aspect 2 of the present disclosure is configured, in Aspect 1 above, to further include: a regulation mechanism configured to carry out regulation of permission of the movement by the floating mechanism; and a regulation mechanism control section configured to control whether or not the regulation by the regulation mechanism is carried out. According to the above configuration, it is possible to control whether or not the permission of the movement by the floating mechanism is carried out.

A conveyance device in accordance with Aspect 3 of the present disclosure is configured, in Aspect 2 above, such that in a case where a predetermined condition is satisfied, the regulation mechanism control section releases the regulation by the regulation mechanism. According to the above configuration, the regulation by the regulation mechanism is released in a case where a predetermined condition is satisfied. Therefore, by setting, as the predetermined condition, a case where it is desired to release the regulation of the floating function of the floating mechanism, it is possible to release the regulation of the floating function in a case where the desired state is reached.

A conveyance device in accordance with Aspect 4 of the present disclosure is configured, in Aspect 3 above, such that the case where the predetermined condition is satisfied is at least one of: (1) a case where a difference between a conveyance speed of the target article and a conveyance speed of the conveyance section exceeds a first threshold, or a difference between a current position of the target article and a current position of the operation robot exceeds a second threshold; (2) a case where an abnormality is detected in the operation robot; and (3) a case where a signal regarding an abnormality is received from equipment for conveying the target article. In a case where a difference between the conveyance speed of the target article and the conveyance speed of the conveyance section becomes large or in a case where a positional shift occurs between the target article and the operation robot, a large load may be applied to the operation robot and the like, which may lead to troubles or damage. Further, also in a case where an abnormality is detected in the operation robot, a load may be applied to the operation robot and the like, which may lead to troubles or damage. Further, also in a case where an abnormality occurs in conveyance equipment for the target article, there is a high possibility that a difference occurs between the conveyance speed of the target article and the conveyance speed of the conveyance section, which may lead to troubles of or damage to the operation robot and the like. According to the above configuration, the regulation by the regulation mechanism is released in such a case, so that the floating mechanism functions. This absorbs the positional shift between the target article and the operation robot, thereby making it possible to reduce a possibility of occurrence of troubles of or damage to the operation robot and the like.

A conveyance device in accordance with Aspect 5 of the present disclosure is configured, in Aspect 4 above, such that the abnormality is detected in the operation robot in a case where a force sensor included in a connection part of the operation robot that is connected to the target article detects an abnormal value or in a case where a measurement value resulting from an action of the operation robot in operation becomes an abnormal value. According to the above configuration, in a situation where a load is likely to be applied to the operation robot, the regulation by the regulation mechanism is released, and the floating mechanism functions. This absorbs the positional shift between the target article and the operation robot, thereby making it possible to reduce a possibility of occurrence of troubles of or damage to the operation robot and the like.

A conveyance device in accordance with Aspect 6 of the present disclosure is configured, in any one of Aspects 2 to 5 above, such that the regulation mechanism carries out the regulation by a biasing force, and in a case where the biasing force becomes smaller than a predetermined value, the regulation mechanism control section releases the regulation. According to the above configuration, it is possible to use the biasing force to control whether or not the permission of the movement by the floating mechanism is carried out.

A conveyance device in accordance with Aspect 7 of the present disclosure is configured, in Aspect 6 above, such that the floating mechanism includes a first part connected to the placement section and a second part connected to the conveyance section, the first part has a protrusion, the second part has a plate part provided with a receiving hole into which the protrusion is fitted, and the regulation mechanism is formed by the protrusion and the plate part and carries out the regulation through fitting of the protrusion into the receiving hole. According to the above configuration, the regulation mechanism that regulates the floating mechanism can be formed by the protrusion and the receiving hole. This makes it possible to realize the regulation mechanism with a simple configuration.

A conveyance device in accordance with Aspect 8 of the present disclosure is configured, in Aspect 7 above, such that with the protrusion fitted into the receiving hole, when the biasing force is equal to or greater than a predetermined value, the regulation mechanism control section does not permit movement in the conveyance direction between the placement section and the conveyance section and when the biasing force is smaller than the predetermined value, the regulation mechanism control section permits the movement in the conveyance direction between the placement section and the conveyance section. According to the above-described configuration, it is possible to control whether or not to regulate the floating function of the floating mechanism, by controlling the biasing force, and thus it is possible to easily control the regulation of the floating function of the floating mechanism.

A conveyance device in accordance with Aspect 9 of the present disclosure is configured, in Aspect 7, such that the floating mechanism includes the first part connected to the placement section and the second part connected to the conveyance section, the first part has a protrusion having a tapered shape and biased toward the conveyance section by a variable biasing force, the second part has a plate part provided with a receiving hole that has a side surface facing in the direction parallel to the conveyance direction and having a tapered shape into which the protrusion is fitted, and the regulation mechanism is formed by the protrusion and the plate part and carries out the regulation through fitting of the protrusion into the receiving hole by the biasing force. According to the above-described configuration, it is possible to form the floating mechanism that permits movement in the conveyance direction between the placement section and the conveyance section, with the protrusion having a tapered shape and the receiving hole having a tapered side surface. This makes it possible to form the floating mechanism with a simple configuration.

A conveyance device in accordance with Aspect 10 of the present disclosure is configured, in any one of Aspects 6 to 9 above, to further include: a detection section configured to detect an abnormality in the operation; and a biasing force control section configured to control the biasing force, wherein when the detection section detects an abnormality, the biasing force control section diminishes the biasing force to be smaller than the predetermined value. According to the above configuration, it is possible to release the regulation of the floating function of the floating mechanism merely at the time of occurrence of an abnormality by diminishing the biasing force to be smaller than the predetermined value, and thus it is possible to carry out highly responsive control with a simple configuration.

A conveyance device in accordance with Aspect 11 of the present disclosure is configured, in any one of Aspects 1 to 5 above, such that the coupling section carries out coupling by a magnetic force, and when generation of the magnetic force is stopped or when a force exceeding the coupling by the magnetic force is applied, regulation of a floating function of the floating mechanism is released. According to the above configuration, it is possible to carry out coupling by a magnetic force and control the regulation of the floating function of the floating mechanism by controlling the magnetic force. Further, it is also possible to create a state in which the regulation of the floating function of the floating mechanism is released also when a force exceeding the magnetic force is applied.

A conveyance device controlling method in accordance with Aspect 12 of the present disclosure is a controlling method for a conveyance device for an operation robot configured to carry out an operation on a target article being conveyed, the conveyance device including a placement section on which the operation robot is placed, a conveyance section configured to move in a direction identical to a conveyance direction of the target article at a conveyance speed identical to that of the target article, and a coupling section coupling the placement section and the conveyance section, the coupling section including a floating mechanism configured to permit movement in the conveyance direction between the placement section and the conveyance section, the conveyance device further including a regulation mechanism control section configured to control regulation of a floating function of the floating mechanism by a regulation mechanism, the method including: a detection step of using the regulation mechanism control section to detect an abnormality in the operation; and a release step of using the regulation mechanism control section to release regulation by the regulation mechanism when the abnormality is detected. According to the above method, when an abnormality is detected, the regulation by the regulation mechanism is released. That is, the regulation of the floating function of the floating mechanism is released. This makes it possible to prevent damage to the operation robot due to a shift of a relative position between the target article and the operation robot at the time of occurrence of an abnormality.

The present disclosure is not limited to the above-described embodiments, but can be altered by a skilled person in the art within the scope of the claims. The present disclosure also encompasses, in its technical scope of the present disclosure, any embodiment derived by appropriately combining technical means disclosed in differing embodiments.

### Reference Signs List

1 Operation robot
10 Conveyance device
11 Coupling section
12 Floating mechanism
121 First part
21 Protrusion
211 Tapered portion
212 Biasing section
122 Second part
22 Plate part
221 Receiving hole
13 Placement section
14 Conveyance section
20 Regulation mechanism
30 Regulation mechanism control section
31 Detection section
32 Biasing force control section
50 Controller
100 Target article

1. A conveyance device for an operation robot configured to carry out an operation on a target article being conveyed, the conveyance device comprising:
a placement section on which the operation robot is placed;
a conveyance section configured to move in a direction identical to a conveyance direction of the target article at a conveyance speed identical to that of the target article; and
a coupling section coupling the placement section and the conveyance section,
the coupling section including a floating mechanism configured to permit movement in a direction parallel to the conveyance direction between the placement section and the conveyance section.

2. The conveyance device according to claim 1, further comprising:
a regulation mechanism configured to carry out regulation of permission of the movement by the floating mechanism; and
a regulation mechanism control section configured to control whether or not the regulation by the regulation mechanism is carried out.

3. The conveyance device according to claim 2, wherein in a case where a predetermined condition is satisfied, the regulation mechanism control section releases the regulation by the regulation mechanism.

4. The conveyance device according to claim 3, wherein the case where the predetermined condition is satisfied is at least one of:
(1) a case where a difference between a conveyance speed of the target article and a conveyance speed of the conveyance section exceeds a first threshold, or a difference between a current position of the target article and a current position of the operation robot exceeds a second threshold;
(2) a case where an abnormality is detected in the operation robot; and
(3) a case where a signal regarding an abnormality is received from equipment for conveying the target article.

5. The conveyance device according to claim 4, wherein the abnormality is detected in the operation robot in a case where a force sensor included in a connection part of the operation robot that is connected to the target article detects an abnormal value or in a case where a measurement value resulting from an action of the operation robot in operation becomes an abnormal value.

6. The conveyance device according to claim 2, wherein
the regulation mechanism carries out the regulation by a biasing force, and
in a case where the biasing force becomes smaller than a predetermined value, the regulation mechanism control section releases the regulation.

7. The conveyance device according to claim 6, wherein
the floating mechanism includes a first part connected to the placement section and a second part connected to the conveyance section,
the first part has a protrusion,
the second part has a plate part provided with a receiving hole into which the protrusion is fitted, and the regulation mechanism is formed by the protrusion and the plate part and carries out the regulation through fitting of the protrusion into the receiving hole.

8. The conveyance device according to claim 7, wherein
with the protrusion fitted into the receiving hole,
when the biasing force is equal to or greater than a predetermined value, the regulation mechanism control section does not permit movement in the conveyance direction between the placement section and the conveyance section and
when the biasing force is smaller than the predetermined value, the regulation mechanism control section permits the movement in the conveyance direction between the placement section and the conveyance section.

9. The conveyance device according to claim 7, wherein
the floating mechanism includes the first part connected to the placement section and the second part connected to the conveyance section,
the first part has a protrusion having a tapered shape and biased toward the conveyance section by a variable biasing force,
the second part has a plate part provided with a receiving hole that has a side surface facing in the direction parallel to the conveyance direction and having a tapered shape into which the protrusion is fitted, and
the regulation mechanism is formed by the protrusion and the plate part and carries out the regulation through fitting of the protrusion into the receiving hole by the biasing force.

10. The conveyance device according to claim 6, further comprising:
a detection section configured to detect an abnormality in the operation; and
a biasing force control section configured to control the biasing force, wherein
when the detection section detects an abnormality, the biasing force control section diminishes the biasing force to be smaller than the predetermined value.

11. The conveyance device according to claim 1, wherein
the coupling section carries out coupling by a magnetic force, and
when generation of the magnetic force is stopped or when a force exceeding the coupling by the magnetic force is applied, regulation of a floating function of the floating mechanism is released.

12. A controlling method for a conveyance device for an operation robot configured to carry out an operation on a target article being conveyed,
the conveyance device including a placement section on which the operation robot is placed, a conveyance section configured to move in a direction identical to a conveyance direction of the target article at a conveyance speed identical to that of the target article, and a coupling section coupling the placement section and the conveyance section,
the coupling section including a floating mechanism configured to permit movement in the conveyance direction between the placement section and the conveyance section,
the conveyance device further including a regulation mechanism control section configured to control regulation of a floating function of the floating mechanism by a regulation mechanism,
the method comprising:
a detection step of using the regulation mechanism control section to detect an abnormality in the operation; and
a release step of using the regulation mechanism control section to release regulation by the regulation mechanism when the abnormality is detected.
